(19) United States
(12) Patent Application Publication
(10) Pub. No.: US 2020/0276529 A1
(43) Pub. Date: Sep. 3, 2020

(54) COMPOSITE CERAMIC FILTER MATERIAL FOR HIGH TEMPERATURE FLUE GAS DUST REMOVAL

(71) Applicant: Peng Shao, Nantong (CN)

(72) Inventor: Peng Shao, Nantong (CN)

(21) Appl. No.: 16/765,468

(22) PCT Filed: Aug. 23, 2018
(86) PCT No.: PCT/CN2018/101898

§ 371 Date: May 19, 2020

(30) Foreign Application Priority Data
Jun. 29, 2018 (CN) 201810697488.6

(51) Int. Cl. B01D 39/20; B01D 46/00; C01B 32/984

(52) U.S. Cl. CPC B01D 39/2075; B01D 46/0001; B01D 2273/20; B01D 2239/10; C01B 32/984

(57) ABSTRACT

The invention provides a composite ceramic filter material for high temperature flue gas dust removal, wherein the filter material is prepared by the following method: provide corn stalk raw material and silicon powder; crush the corn stalk raw material and pyrolyze the crushed corn stalk raw material to obtain carbonized corn stalks; spread silicon powders on, the corn stalk raw material to obtain mixed powder, perform first high-temperature heat treatment on the mixed powder to obtain silicon carbide powder; add silicon carbide powder into ethanol; add PVB to the ethanol suspension of silicon carbide to obtain a dispersion solution of silicon carbide; perform surface treatment on the aluminum alloy base material; porous silicon carbide film is formed on the surface of the surface treated aluminum alloy by air spraying technology; perform pre-sintering on the porous silicon carbide film; perform sintering on the pre-sintered porous silicon carbide film.

### TECHNICAL FIELD

The present invention relates to the technical field of high-temperature resistant environmental protection materials, especially a composite ceramic filter material for high temperature flue gas dust removal.

### BACKGROUND TECHNOLOGY

The current social environmental protection issue has become a hot topic because its influence on human society can no longer be ignored. Among them, atmospheric particle pollution has become an important environmental factor. In addition, dust could not only pollutes the environment, but also that if the gas mixed with particulate impurities goes into some of the equipment such as steam turbines and diesel engines, it will cause serious damage to the steam turbine or diesel engine and shorten their service life. Therefore, it has become a hot spot to purify and dust the high temperature and high pressure gas. The way to reduce pollution in diesel and hybrid diesel vehicles is to reduce the fuel consumption, CO₂ emissions and dependence on fossil fuels. However, in general, the emission standards for motor vehicles are increasingly restricted, especially for diesel-powered engine vehicles. The emission standards set by environmental protection laws and regulations are gradually improved. The exhaust gas generated by the combustion of diesel vehicles must also be strictly controlled. The exhaust gas after-treatment device should be installed, and exhaust gas should be treated by physical and chemical reactions, only by these measures, the emission of harmful nitrogen oxides and carbon particles can be reduced, so that reducing the atmospheric environmental load.

The information disclosed in this background technology section is only intended to provide an understanding of the general background of, this invention, and should not be construed as acknowledging or, implying in any way that the information composition is the existing technology known to the general technical personnel in the field.

### SUMMARY OF THE INVENTION

The purpose of the invention is to provide a composite ceramic filter material for high temperature flue gas dust removal, thereby overcoming the shortcomings of existing technologies.

This invention provides a composite ceramic filter material for high temperature flue gas dust removal, characterized in that: the filter material is prepared by the following method: provide corn stalk raw materials and silicon powder; crush the corn stalk raw material and pyrolyze the crushed corn stalk raw material to obtain carbonized corn stalks; spread silicon powders on the corn stalk raw material to obtain mixed powder; perform first high-temperature heat treatment on, the mixed powder to obtain silicon carbide powder; add silicon carbide powder into ethanol; add PVB to the ethanol suspension of silicon carbide to obtain a dispersion solution, of silicon carbide; perform surface treatment on the aluminum alloy base material; then the porous silicon carbide film is, formed on the surface of the surface treated aluminum alloy by air spraying technology; perform pre-sintering on the porous silicon carbide film; perform sintering on the pre-sintered porous silicon carbide film.

Preferably, in the technical scheme mentioned above, the specific process of crushing the corn stalk raw material and pyrolyzing the crushed corn stalk raw material to obtain carbonized corn stalks is as follows: the pyrolysis air pressure is lower than 0.01 Pa, the pyrolysis temperature is 900-1000° C., and the pyrolysis time was 3-4 h.

Preferably, in the technical scheme mentioned above, the specific process of the first high temperature heat treatment is that, the first high temperature heat treatment atmosphere is nitrogen, the first high temperature heat treatment temperature is 1600-1700° C., the first high temperature heat treatment time is 4-5 h, the heating rate of the first high temperature heat treatment is that, when the temperature is 300-1000° C., the heating rate is 40-50° C./min; when the temperature is more than 1000° C., the heating rate is 50-60° C./min.

Preferably, in the technical scheme mentioned above, in the dispersion solution of silicon carbide, the PVB concentration is 15-18 wt % and the silicon carbide concentration is 300-400 g/L.

Preferably, in the technical scheme mentioned above, the surface treatment performed on the aluminum alloy base material is that: perform surface abrasive blasting on the aluminium alloy to make the surface roughness of aluminum alloy as Ra 100-130.

Preferably, in the technical scheme mentioned above, porous silicon carbide film is formed on the surface of the surface treated aluminum alloy by air spraying technology, specifically, the nozzle diameter is 2-4 mm, the spraying distance is 100-150 mm, the spraying pressure is 1-3 MPa, and the spraying liquid output is 600-800 mL/min.

Preferably, in the technical scheme mentioned above, the specific process of pre-sintering performed on the porous silicon carbide film is: the pre-sintering has two stages: the first stage pre-sintering temperature is 500-600° C., and the first stage pre-sintering time is 2-3 h, the second stage pre-sintering temperature is 800-900° C., and the first stage pre-sintering time is 4-5 h.

Preferably, in the technical scheme mentioned above, the sintering performed on the pre-sintered porous silicon carbide film is specifically as follows: the sintering temperature is 1700-1800° C., the sintering time is 4-5 h, the sintering heating rate is that, when the sintering temperature is 300-1000° C., the heating rate is 40-50° C./min, when the sintering temperature is 1000-1400° C., the heating rate is 50-60° C./min; when the sintering temperature is more than 1400° C., the heating rate is 20-30° C./min.

Compared with existing technology, the present invention has the following beneficial advantages: a lot of research has been done on the preparation and surface modification of silicon carbide, but the qualitative research conclusion of its application has not been researched. Due to lack of reliable experimental data and the feasible preparation process technology, the existing technology still cannot directly apply porous silicon carbide to the exhaust gas, treatment of diesel engines, so at present, the exhaust gas treatment materials is still using the three-way catalyst. However, the price of three-way catalyst is relatively higher, and it is easy to occur catalyst, and the requirements for its use conditions are more stringent. In contrast, the exhaust gas treatment of silicon carbide porous materials is completely based on the adsorption theory, so there is no restriction of reaction conditions and the use conditions are extremely relaxed, and even if the silicon carbide material is broken, it can continue to be used. In order to solve the shortage of effective technology for preparing porous silicon carbide in the field, the present invention innovatively proposes a novel preparation method of porous silicon carbide. The raw materials of the method are readily available, meanwhile the waste utilization is possible, and the method flow of the invention is easy to realize, which can effectively reduce the cost of adsorption materials.

### DETAILED DESCRIPTION OF THE EMBODIMENTS

The following implementations are provided in order to better illustrate this present invention, and to communicate the scope of the invention fully to the technical personnel in this field.

### IMPLEMENTATION EXAMPLE 1

The filter material is prepared by the following method: provide corn stalk raw materials and silicon powder; crush the corn stalk raw material and pyrolyze the crushed corn stalk raw material to obtain carbonized corn stalks; spread silicon powders on the corn stalk raw material to obtain mixed powder; perform first high-temperature heat treatment on the mixed powder to obtain silicon carbide powder; add silicon carbide powder into ethanol; add PVB to the ethanol suspension of silicon carbide to obtain a dispersion solution of silicon carbide; perform surface treatment on the aluminum alloy base material; then the porous silicon carbide film is formed on the surface of the surface treated aluminum alloy by air spraying technology; perform pre-sintering on the porous silicon carbide film; perform sintering on the pre-sintered porous silicon carbide film. The specific process of crushing the corn stalk raw material and pyrolyzing the crushed corn stalk raw material to obtain carbonized corn stalks is as follows: the pyrolysis air pressure is lower than 0.01 Pa, the pyrolysis temperature is 900° C., and the pyrolysis time was 3 h. The specific process of the first high temperature heat treatment is that, the first high temperature heat treatment atmosphere is nitrogen, the first high temperature heat treatment temperature is 1600° C., the first high temperature heat treatment time is 4 h, the heating rate of the first high temperature heat treatment is that, when the temperature is 300-1000° C., the heating rate is 40° C/min; when the temperature is more than 1000° C., the heating rate is 50° C./min. In the dispersion solution of silicon carbide, the PVB concentration is 15 wt % and the silicon carbide concentration is 300 g/L. The surface treatment performed on the aluminum alloy base material is that: perform surface abrasive blasting on the aluminium alloy to make the surface roughness of aluminum alloy as Ra 100. The porous silicon carbide film is formed on the surface of the surface treated aluminum alloy by air spraying technology, specifically, the nozzle diameter is 2 mm, the spraying distance is 100 mm, the spraying pressure is 1 MPa, and the spraying liquid output is 600 mL/min. The specific process of pre-sintering performed on the porous silicon carbide film is: the pre-sintering has two stages: the first stage pre-sintering temperature is 500° C., and the first stage pre-sintering time is 2 h, the second stage pre-sintering temperature is 800° C., and the first stage pre-sintering time is 4 h. The sintering performed on the pre-sintered porous silicon carbide film is specifically as follows: the sintering temperature is 1700° C., the sintering time is 4 h, the sintering heating rate is that, when the sintering temperature is 300-1000° C., the heating, rate is 40° C./min, when the sintering temperature is 1000-1400° C., the heating rate is 50° C./min; when the sintering temperature is more than 1400° C., the heating rate is 20° C./min.

### IMPLEMENTATION EXAMPLE 2

The filter material is prepared by the following method: provide corn stalk raw materials and silicon powder; crush the corn stalk raw material and pyrolyze the crushed corn stalk raw material to obtain carbonized corn stalks; spread silicon powders on the corn stalk raw material to obtain mixed powder; perform first high-temperature heat treatment on the mixed powder to obtain silicon carbide powder; add silicon carbide powder into ethanol; add PVB to the ethanol suspension of silicon carbide to obtain a dispersion solution of silicon carbide; perform surface treatment on, the aluminum alloy base material; then the porous silicon carbide film is formed on the surface of the surface treated aluminum alloy by air spraying technology; perform pre-sintering on the porous silicon carbide film; perform sintering on the pre-sintered porous silicon carbide film. The specific process of crushing the corn stalk raw material and pyrolyzing the crushed corn stalk raw material to obtain carbonized corn stalks is as follows: the pyrolysis air pressure is lower than 0.01 Pa, the pyrolysis temperature is 1000° C., and the pyrolysis time was 4 h. The specific process of the first high temperature heat treatment is that, the first high temperature heat treatment atmosphere is nitrogen, the first high temperature heat treatment temperature is 1700° C., the first high temperature heat treatment time is 5 h, the heating rate of the first high temperature heat treatment is that, when the temperature is 300-1000° C., the heating rate is 50° C./min; when the temperature is more than 1000° C., the heating rate is 60° C/min. In the dispersion solution of silicon carbide, the PVB concentration is 18 wt % and the silicon carbide concentration is 400 g/L. The surface treatment performed on the aluminum alloy base material is that: perform surface abrasive blasting on the aluminium alloy to make the surface roughness of aluminum alloy as Ra 130. The porous silicon carbide film is formed on the surface of the surface treated aluminum alloy by air spraying technology, specifically, the nozzle diameter is 4 mm, the spraying distance is 150 mm, the spraying pressure is 3 MPa, and the spraying liquid output is 800 mL/min. The specific process of pre-sintering performed on the porous silicon carbide film is: the pre-sintering has two stages: the first stage pre-sintering temperature is 600° C., and the first stage pre-sintering time is 3 h, the second stage pre-sintering temperature is 900° C., and the first stage pre-sintering time is 5 h. The sintering performed on the pre-sintered porous silicon carbide film is specifically as follows: the sintering temperature is 1800° C., the sintering time is 5 h, the sintering heating rate is that, when, the sintering temperature is 300-1000° C., the heating rate is 50° C./min; when the sintering temperature is 1000-1400° C., the heating rate is 60° C./min; when the sintering temperature is more than 1400° C., the heating rate is 30° C./min.

### IMPLEMENTATION EXAMPLE 3

The filter material is prepared by the following method: provide corn stalk raw materials and silicon powder; crush the corn stalk raw material and pyrolyze the crushed corn stalk raw material to obtain carbonized corn stalks; spread silicon powders on the corn stalk raw material to obtain mixed powder; perform first high-temperature heat treatment on the mixed powder to obtain silicon carbide powder; add silicon carbide powder into ethanol; add PVB to the ethanol suspension of silicon carbide to obtain a dispersion solution of silicon carbide; perform surface treatment on the aluminum alloy base material; then the porous silicon carbide film is formed on the surface of the surface treated aluminum alloy by air spraying technology; perform pre-sintering on the porous, silicon carbide film; perform sintering on the pre-sintered porous silicon carbide film. The specific process of crushing the corn stalk raw material and pyrolyzing the crushed corn stalk raw material to obtain carbonized corn stalks is as follows: the pyrolysis air pressure is lower than 0.01 Pa, the pyrolysis temperature is 950° C., and the pyrolysis time was 3.5 h. The specific process of the first high temperature heat treatment is that, the first high temperature heat treatment atmosphere is nitrogen, the first, high temperature heat treatment temperature is 1650° C., the first high temperature heat treatment time is 4.5 h, the heating rate of the first high temperature heat treatment is that, when the temperature is 300-1000° C., the heating rate is 45° C./min; when the temperature is more than 1000° C., the heating rate is 55° C./min. In the dispersion solution of silicon carbide, the PVB concentration is 16 wt % and the silicon carbide concentration is 350 g/L. The surface treatment performed on the aluminum alloy base material is that: perform surface abrasive blasting on the aluminium alloy to make the surface roughness of aluminum alloy as Ra 120. The porous silicon carbide film is formed on the surface of the surface treated aluminum alloy by air spraying technology, specifically, the nozzle diameter is 3 mm, the spraying distance is 120 mm, the spraying pressure is 2 MPa, and the spraying liquid output is 700 mL/min. The specific process of pre-sintering performed on the porous silicon carbide film is: the pre-sintering has two stages: the first stage pre-sintering temperature is 550° C., and the first stage pre-sintering time is 2.5 h, the second stage pre-sintering temperature is 850° C., and the first stage pre-sintering time is 4.5 h. The sintering performed on the pre-sintered porous silicon carbide film is specifically as follows: the sintering temperature is 1750° C., the sintering time is 4.5 h, the sintering heating rate is that, when the sintering temperature is 300-1000° C., the heating rate is 45° C./min; when the sintering temperature is 1000-1400° C., the heating rate is 55° C./min; when the sintering temperature is more than 1400° C., the heating rate is 25° C./min.

### IMPLEMENTATION EXAMPLE 4

The filter material is prepared by the following method: provide corn stalk raw materials and silicon powder; crush the corn stalk raw material and pyrolyze the crushed corn stalk raw material to obtain carbonized corn stalks; spread silicon powders on the corn stalk raw material to obtain mixed powder; perform first high-temperature heat treatment on the mixed powder to obtain silicon carbide powder; add silicon carbide powder into ethanol; add PVB to the ethanol suspension of silicon carbide to obtain a dispersion solution of silicon carbide; perform surface treatment on the aluminum alloy base material; then the porous silicon carbide film is formed on the surface of the surface treated aluminum alloy by air spraying technology; perform pre-sintering on the porous silicon carbide film; perform sintering on the pre-sintered porous silicon carbide film. The specific process of crushing the corn stalk raw material and pyrolyzing the crushed corn stalk raw material to obtain carbonized corn stalks is as follows: the pyrolysis air pressure is lower than 0.01 Pa, the pyrolysis temperature is 1200° C., and the pyrolysis time was 5 h. The specific process of the first high temperature heat treatment is that, the first high temperature heat treatment atmosphere is nitrogen, the first high temperature heat treatment temperature is 1800° C., the first high temperature heat treatment time is 6 h, the heating rate of the first high temperature heat treatment is that, when the temperature is 300-1000° C., the heating rate is 60° C./min; when the temperature is more than 1000° C., the heating rate is 70° C./min. In the dispersion solution of silicon carbide, the PVB concentration is 16 wt % and the silicon carbide concentration is 350 g/L. The surface treatment performed on the aluminum alloy base material is that: perform surface abrasive blasting on the aluminium alloy to make the surface roughness of aluminum alloy as Ra 120. The porous silicon carbide film is formed on the surface of the surface treated aluminum alloy by air spraying technology, specifically, the nozzle diameter is 3 mm, the spraying distance is 120 mm, the spraying pressure is 2 MPa, and the spraying liquid output is 700 mL/min. The specific process of pre-sintering performed on the porous silicon carbide film is: the pre-sintering has two stages: the first stage pre-sintering temperature is 550° C., and the first stage pre-sintering time is 2.5 h, the second stage pre-sintering temperature is 850° C., and the first stage pre-sintering time is 4.5 h. The sintering performed on the pre-sintered porous silicon carbide film is specifically as follows: the sintering temperature is 1750° C., the sintering time is 4.5 h, the sintering heating rate is that, when the sintering temperature is 300-1000° C., the heating rate is 45° C./min; when the sintering temperature is 1000-1400° C., the heating rate is 55° C./min; when the sintering temperature is more than 1400° C., the heating rate is 25° C./min.

### IMPLEMENTATION EXAMPLE 5

The filter material is prepared by the following method: provide corn stalk raw materials and silicon powder; crush the corn stalk raw material and pyrolyze the crushed corn stalk raw material to obtain carbonized corn stalks; spread silicon powders on the corn stalk raw material to obtain mixed powder; perform first high-temperature heat treatment on the mixed powder to obtain silicon carbide powder; add silicon carbide powder into ethanol; add PVB to the ethanol suspension of silicon carbide to obtain a dispersion solution of silicon carbide; perform surface treatment on the aluminum alloy base material; then the porous silicon carbide film is formed on the surface of the surface treated aluminum alloy by air spraying technology; perform pre-sintering on the porous silicon carbide film; perform sintering on the pre-sintered porous silicon carbide film. The specific process of crushing the corn stalk raw material and pyrolyzing the crushed corn stalk raw material to obtain carbonized corn stalks is as follows: the pyrolysis air pressure is lower than 0.01 Pa, the pyrolysis temperature is 950° C., and the pyrolysis time was 3.5 h. The specific process of the first high temperature heat treatment is that, the first high temperature heat treatment atmosphere is nitrogen, the first high temperature heat treatment temperature is 1650° C., the first high temperature heat treatment time is 4.5 h, the heating rate of the first high temperature heat treatment is that, when the temperature is 300-1000° C., the heating rate is 45° C./min; when the temperature is more than 1000° C., the heating rate is 55° C./min. In the dispersion solution of silicon carbide, the PVB concentration is 10 wt % and the silicon carbide concentration is 100 g/L. The surface treatment performed on the aluminum alloy base material is that: perform surface abrasive blasting on the aluminium alloy to make the surface roughness of aluminum alloy as Ra 150. The porous silicon carbide film is formed on the surface of the surface treated aluminum alloy by air spraying technology, specifically, the nozzle diameter is 5 mm, the spraying distance is 200 mm, the spraying pressure is 0.5 MPa, and the spraying liquid output is 1000 mL/min. The specific process of pre-sintering performed on the porous silicon carbide film is: the pre-sintering has two stages: the first stage pre-sintering temperature is 550° C., and the first stage pre-sintering time is 2.5 h, the second stage pre-sintering temperature is 850° C., and the first stage pre-sintering time is 4.5 h. The sintering performed on the pre-sintered porous silicon carbide film is specifically as follows: the sintering temperature is 1750° C., the sintering time is 4.5 h, the sintering heating rate is that, when the sintering temperature is 300-1000° C., the heating rate is 45° C./min; when the sintering temperature is 1000-1400° C. the heating rate is 55° C./min; when the sintering temperature is more than 1400° C., the heating rate is 25° C./min.

### IMPLEMENTATION EXAMPLE 6

The filter material is prepared by the following method: provide corn stalk raw materials and silicon powder; crush the corn stalk raw material and pyrolyze the crushed corn stalk raw material to obtain carbonized corn stalks; spread silicon powders on the corn stalk raw material to obtain mixed powder; perform first high-temperature heat treatment on the mixed powder to obtain silicon carbide powder; add silicon carbide powder into ethanol; add PVB to the ethanol suspension of silicon carbide to obtain a dispersion solution of silicon carbide; perform surface treatment on the aluminum alloy base material; then the porous silicon carbide film is formed on the surface of the surface treated aluminum alloy by air spraying technology; perform pre-sintering on the porous silicon carbide film; perform sintering on the pre-sintered porous silicon carbide film. The specific process of crushing the corn stalk raw material and pyrolyzing the crushed corn stalk raw material to obtain carbonized corn stalks is as follows: the pyrolysis air pressure is lower than 0.01 Pa, the pyrolysis temperature is 950° C., and the pyrolysis time was 3.5 h. The specific process of the first high temperature heat treatment is that, the first high temperature heat treatment atmosphere is nitrogen, the first, high, temperature heat treatment temperature is 1650° C., the first high, temperature heat treatment time is 4.5 h, the heating rate of the first high temperature heat treatment is that, when the temperature is 300-1000° C., the heating rate is 45° C./min; when the temperature is more than 1000° C., the heating rate is 55° C./min. In the dispersion solution of silicon carbide, the PVB concentration is 16 wt % and the silicon carbide concentration is 350 g/L. The surface treatment performed on the aluminum alloy base material is that: perform surface abrasive blasting on the aluminium alloy to make the surface roughness of aluminum alloy as Ra 120. The porous silicon carbide film is formed on the surface of the surface treated aluminum alloy by air spraying technology, specifically, the nozzle diameter is 3 mm, the spraying distance is 120 mm, the spraying pressure is 2 MPa, and the spraying liquid output is 700 mL/min. The specific process of pre-sintering performed on the porous silicon carbide film is: the pre-sintering has two stages: the first stage pre-sintering temperature is 700° C., and the first stage pre-sintering time is 4 h, the second stage pre-sintering temperature is 1000° C. and the first stage pre-sintering time is 6 h. The sintering performed on the pre-sintered porous silicon carbide film is specifically as follows: the sintering temperature is 1750° C., the sintering time is 4.5 h, the sintering heating rate is that, when the sintering temperature is 300-1000° C., the heating rate is 45° C./min; when the sintering temperature is 1000-1400° C., the heating rate is 55° C./min; when the sintering temperature is more than 1400° C., the heating rate is 25° C./min.

### IMPLEMENTATION EXAMPLE 7

The filter material is prepared by the following method: provide corn stalk raw materials and silicon powder; crush the corn stalk raw material and pyrolyze the crushed corn stalk raw material to obtain carbonized corn stalks; spread silicon powders on the corn stalk raw material to obtain mixed powder; perform first high-temperature heat treatment on the mixed powder to obtain silicon carbide powder; add silicon carbide powder into ethanol; add PVB to the ethanol suspension of silicon carbide to obtain a dispersion solution of silicon carbide; perform surface treatment on the aluminum alloy base material; then the porous silicon carbide film is formed on the surface of the surface treated aluminum alloy by air spraying technology; perform pre-sintering, on the porous silicon carbide film; perform sintering on the pre-sintered porous silicon carbide film. The specific process of crushing the corn stalk raw material and pyrolyzing the crushed corn stalk raw material to obtain carbonized corn stalks is as follows: the pyrolysis air pressure is lower than 0.01 Pa, the pyrolysis temperature is 950° C., and the pyrolysis time was 3.5 h. The specific process of the first high temperature heat treatment is that, the first high temperature heat treatment atmosphere is nitrogen, the first high temperature heat treatment temperature is 1650° C., the first high temperature heat treatment time is 4.5 h, the heating rate of the first high temperature heat treatment is that, when the temperature is 300-1000° C., the heating rate is 45° C./min; when the temperature is more than 1000° C., the heating rate is 55° C./min. In the dispersion solution of silicon carbide, the PVB concentration is 16 wt % and the silicon carbide concentration is 350 g/L. The surface treatment performed on the aluminum alloy base material is that: perform surface abrasive blasting on the aluminium alloy to make the surface roughness of aluminum alloy as Ra 120. The porous silicon carbide film is formed on the surface of the surface treated aluminum alloy by air spraying technology, specifically, the nozzle diameter is 3 mm, the spraying distance is 120 mm, the spraying pressure is 2 MPa, and the spraying liquid output is 700 mL/min. The specific process of pre-sintering performed on the porous silicon carbide film is: the pre-sintering has two stages: the first stage pre-sintering temperature is 550° C., and the first stage pre-sintering time is 2.5 h, the second stage pre-sintering temperature is 850° C., and the first stage pre-sintering time is 4.5 h. The sintering performed on the pre-sintered porous silicon carbide film is specifically as follows: the sintering temperature is 500° C., the sintering time is 3 h, the sintering heating rate is that, when the sintering temperature is 300-1000° C., the heating rate is 30° C./min; when the sintering temperature is 1000-1400° C., the heating rate is 40° C./min; when the sintering temperature is more than 1400° C., the heating rate is 10° C./min.

The adsorption rates for nitrogen oxides and unburned hydrocarbons were tested for implementation examples 1-7. The test method is in accordance with national standards and the test results were normalized relative to example 1.

TABLE 1

| | nitrogen oxides | unburned hydrocarbons |
|---|---|---|
| | adsorption rates | adsorption rates |
| implementation examples 1 | 100% | 100% |
| implementation examples 2 | 103% | 97% |
| implementation examples 3 | 104% | 101% |
| implementation examples 4 | 82% | 73% |
| implementation examples 5 | 81% | 81% |
| implementation examples 6 | 73% | 69% |
| implementation examples 7 | 71% | 70% |

The foregoing description is only some specific exemplary embodiments of the present invention, but the protection scope of the present invention is not limited to this. Any readily conceivable changes or replacement by a technician familiar with the technical field within the technical scope disclosed by the invention shall be covered by the protection of the invention. Therefore, the scope of the invention is intended to be limited by claims and their equivalents.

1. A composite ceramic filter material for high temperature flue gas dust removal, characterized in that: the filter material is prepared by the following method:
Provide corn stalk raw materials and silicon powder;
Crush the corn stalk raw material and pyrolyze the crushed corn stalk raw material to obtain carbonized corn stalks;
Spread silicon powders on the corn stalk raw material to obtain mixed powder;
Perform first high-temperature heat treatment on the mixed powder to obtain silicon carbide powder;
Add silicon carbide powder into ethanol;
Add PVB to the ethanol suspension of silicon carbide to obtain a dispersion solution of silicon carbide,
Perform surface treatment on the aluminum alloy base material; Porous silicon carbide film is formed on the surface of the surface treated aluminum alloy by air spraying technology;
Perform pre-sintering on the porous silicon carbide film;
Perform sintering on the pre-sintered porous silicon carbide film.

2. The composite ceramic filter material for high temperature flue gas dust removal mentioned in claim 1, characterized in that: crush the corn stalk raw material and pyrolyze the crushed corn stalk raw material to obtain carbonized corn stalks, and the specific process is as follows: The pyrolysis air pressure is lower than 0.01 Pa, the pyrolysis temperature is 900-1000° C., and the pyrolysis time was 3-4 h.

3. The composite ceramic filter material for high temperature flue gas dust removal mentioned in claim 1, characterized in that: the specific process of the first high temperature heat treatment is: the first high temperature heat treatment, atmosphere is nitrogen, the first high temperature heat treatment temperature is 1600-1700° C., the first high temperature heat treatment time is 4-5 h, the heating rate of the first high temperature heat treatment is that, when the temperature is 300-1000° C., the heating rate is 40-50° C./min; when the temperature is more than 1000° C., the heating rate is 50-60° C./min.

4. The composite ceramic filter material for high temperature flue gas dust removal mentioned in claim 1, characterized in that: in the dispersion solution of silicon carbide, the PVB concentration is 15-18 wt % and the silicon carbide concentration is 300-400 g/L.

5. The composite ceramic filter material for high temperature flue gas dust removal mentioned in claim 1, characterized in that: the surface treatment performed on the aluminum alloy base material is that: perform surface abrasive blasting on the aluminium alloy to make the surface roughness of aluminum alloy as ra 100-130.

6. The composite ceramic filter material for high temperature flue gas dust removal mentioned in claim 1, characterized in that: porous silicon carbide film is formed on the surface of the surface treated aluminum alloy by air spraying technology, specifically, the nozzle diameter is 2-4 mm, the spraying distance is 100-150 mm, the spraying pressure is 1-3 mpa, and the spraying liquid output is 600-800 mL/min.

7. The composite ceramic filter material for high temperature flue gas dust removal mentioned in claim 1, characterized in that: the specific process of pre-sintering performed on the porous silicon carbide film is: the pre-sintering has two stages: the first stage pre-sintering temperature is 500-600° C., and the first stage pre-sintering time is 2-3 h, the second stage pre-sintering temperature is 800-900° C., and the first stage pre-sintering time is 4 -5 h.

8. The composite ceramic filter material for high temperature flue gas dust removal mentioned in claim 1, characterized in that: the sintering performed on the pre-sintered porous silicon carbide film is specifically as follows: the sintering temperature is 1700-1800° C., the sintering time is 4-5 h, the sintering heating rate is that, when the sintering temperature is 300-1000° C., the heating rate is 40-50° C./min; when the sintering temperature is 1000-1400° C., the heating rate is 50-60° C./min; when the sintering temperature is more than 1400° C., the heating rate is 20-30° C./min.
